(19) United States
(12) Patent Application Publication
(10) Pub. No.: US 2009/0040218 A1
(43) Pub. Date: Feb. 12, 2009

(54) FITTING CURVES FROM ONE MODEL TO ANOTHER

(76) Inventors: Ken Museth, Venice, CA (US); Doug Roble, Venice, CA (US); Mattias Bergbom, Venice, CA (US)

Correspondence Address: PERKINS COIE LLP, P.O. BOX 1208, SEATTLE, WA, 98111-1208, US

(21) Appl. No.: 12/179,507

(22) Filed: Jul. 24, 2008

Related U.S. Application Data
(60) Provisional application No. 60/954,213, filed on Aug. 6, 2007.

(51) Int. Cl. G06T 17/00

(52) U.S. Cl. 345/420

(57) ABSTRACT

A method and system for variational and iterative fitting of complex curves (such as Super Helix curves) to arbitrary regular parametric curves is described, called a curve fitting system. The curve fitting system uses data reduction and error-analysis often found in mesh decimation schemes as well as non-linear minimization. The curve fitting system takes full advantage of the large body of existing work on parametric curve modeling, while utilizing new and beneficial curve models for simulation.

### CLAIM OF PRIORITY

This application claims priority to U.S. Provisional Patent Application No. 60/954,213 entitled “Fitting Curves From One Model To Another”, which was filed on Aug. 6, 2007, by Doug Roble, et al., the contents of which are expressly incorporated by reference herein.

### BACKGROUND

Computer animation is the art of creating moving images via the use of computers, also referred to as CGI (computer generated imagery or computer generated imaging), especially when used in films. Computer animation is generally divided into two steps: modeling and simulation. Modeling deals with establishing physically correct quantitative relationships between real systems and models of those real systems. For example, modeling hair might involve establishing the effect of various interactions with hair such as bending, twisting, and stretching. Some hair may behave different from other hair, such as if the hair is curly, stiff, or wavy. Simulation deals with implementing the models in such a way that the results match those of the real system to a high degree. The degree of validity measures the extent to which the model matches data from the real system. For 3D animations, simulation is used to render frames after modeling is complete. For example, once a model exists for hair, the hair can be animated in a variety of situations, such as on a model of a person that is running. For movies, the rendered frames are transferred to a different format or medium such as film or digital video. Other environments, such as video games, dynamically render frames in real time based on mathematical models.

Traditionally, the formal modeling of systems has been via a mathematical model, which attempts to find analytical solutions enabling the prediction of the behavior of the system from a set of parameters and initial conditions. Computer simulation is often used as an adjunct to, or substitution for, modeling systems for which simple closed form analytic solutions are not possible. There are many different types of computer simulation; the common feature they all share is the attempt to generate a sample of representative scenarios for a model in which a complete enumeration of all possible states would be prohibitive or impossible.

Simulating human hair is recognized as one of the most difficult tasks in computer animation. Traditional models fail to account for the nonlinear behavior of hair strands with respect to bending and twisting. Human hair is a very complex material, consisting of hundreds of thousands of very thin, inextensible strands that interact with each other and with the body. Unlike solids or fluids, which have been studied for over a century and well modeled by classical equations, hair remains a largely unsolved problem that is difficult to describe with traditional models. Modeling hair dynamics raises a number of difficulties. First, each individual strand has a complex nonlinear mechanical behavior, strongly related to its natural shape: smooth, wavy, curly, or fuzzy. Second, the dynamics of an assembly of strands takes on a collective behavior. Last, the simulation of a full head of hair raises issues in terms of efficiency and computational costs, because each hair requires a certain amount of computing power to simulate.

Many commercially available packages are available for performing computer animation. Some examples of animation software are Amorphium, Art of Illusion, Poser, Ray Dream Studio, Bryce, Maya, Blender, TrueSpace, Lightwave, 3D Studio Max, SoftImage XSI, Alice, and Adobe Flash (2D). Professional animators of movies, television, and video sequences in computer games make photorealistic animation with high detail. This level of quality for movie animation uses powerful workstation computers, often networked together in a render farm, to allow the production of a computer-animated movie in about one to five years (this process is not comprised solely of rendering, however). Many tools exist for simulation of physical objects, such as the simulation of grooming hair. These tools commonly use non-uniform rational B-spline (NURBS) curves to represent hair and other soft bodies.

As more complex models for physical objects such as hair are discovered, it is difficult to go from existing tools and known curves to the new models. For example, one group has proposed using Cosserat curves with piecewise constant curvature—so called Super-Helix curves—for dynamic simulations of hair. This approach has two advantages over previous work: 1) it can easily handle curly hair and 2) it can preserve hair's length during deformations (i.e., prevent stretching). These advantages extend naturally from the Super Helix mathematical model. However, the disadvantage of such a model is that curves (e.g., such as hair strands) must be represented in an unfamiliar and unintuitive parameter space of curvatures and twists. Consequently, the modeling and styling of Super Helix curves is a challenging task that was not addressed by the group that discovered them. Given a particular known parametric curve previously used for modeling and simulation, it is difficult to find an equivalent Super Helix curve or other complex curve to improve the simulation.

### BRIEF DESCRIPTION OF THE DRAWINGS

FIG. 1 illustrates the components of a curve fitting system in one embodiment.

FIG. 2 illustrates the simulation of human hair according to one model.

FIG. 3 illustrates the fitting of a Super-Helix curve to an arbitrary NURBS curve.

FIG. 4 illustrates a fitted Super-Helix curve and the source NURBS curve.

FIG. 5 is a flow diagram that illustrates the steps performed by the curve fitting system in one embodiment.

FIG. 6 is a flow diagram that illustrates the steps performed by the segment fitting component in one embodiment.

FIG. 7 is a flow diagram that illustrates the steps performed by the segment reducing component in one embodiment.

### DETAILED DESCRIPTION

A method and system for variational and iterative fitting of complex curves (such as Super Helix curves) to arbitrary regular parametric curves is described, called a curve fitting system. The curve fitting system uses data reduction and error-analysis often found in mesh decimation schemes as well as non-linear minimization. The curve fitting system takes full advantage of the large body of existing work on parametric curve modeling, while utilizing new and beneficial curve models for simulation. For example, the system allows easy conversion between NURBS curves and Super Helix curves so that the NURBS curves can be used for modeling and Super Helix curves can be used for dynamic simulation.

An initial fit of a target curve is created using a super-helix with a large number of sub-segments. An iterative algorithm combines neighboring segments that satisfy certain criteria, such as direction and curvedness, thereby reducing the initial over-populated super-helix to one that has a smaller number of sub-segments. A source parametric curve is fit using these sub-segments. The following sections describe each of the steps typically performed by the curve fitting system. First, the subdivision section describes how the curve fitting system breaks the curve up into smaller segments. Next, the segment fitting section describes how the curve fitting system fits a segment of the target curve to each segment of the source curve. Next, the error analysis section describes how the curve fitting system measures the error in the fit for each segment as well as the overall error. Finally, the segment reduction section describes how the curve fitting system simplifies the simulation of the new target curve by analyzing the error of removing any particular segment and removing those segments that introduce the least error to achieve a satisfactory fit at an acceptable computational cost for simulation.

### Subdivision

In some embodiments, the curve fitting system first divides the source parametric curve into multiple segments, so that each segment can be fit during segment fitting individually. The source curve can be divided according to many different methods. For example, a user of the system may specify a maximum segment length and the curve fitting system may divide the source curve into segments of the specified maximum segment length. As another example, the curve fitting system may produce longer segments in parts of the curve where the curve changes less, and shorter segments in parts with numerous changes. In some embodiments, the curve fitting system performs high-resolution fit, where the variance in Frenet-Serret curvature of the source curve drives an adaptive subdivision scheme. The Frenet-Serret formulas describe the properties of the curve locally at each point, and in particular the curvature. By dividing segments according to the variance in curvature, the curve fitting system can choose segments to which to fit the target curve with less error, and thus less error accumulates after iterating over the entire source curve.

### Segment Fitting

In general terms we wish to fit a parametric (e.g., NURBS) source curve, parameterized in arc length, with a curve (e.g., Super Helix), with N piecewise elements each having a constant curvature.

In some embodiments, the curve fitting system uses a fitting technique inspired by standard mesh decimation schemes. Typical mesh decimation removes triangles from a 3D surface adding distortion, but simplifying the rendering of the surface. The curve fitting system fits each target curve segment locally using an error metric based on the segment endpoint's position, orientation, and the average curvature over the segment. This provides an optimal starting point for subsequent segments and limits the accumulated error while maintaining a visibly appealing shape.

In some embodiments, Frenet-Serret analysis of the source curve efficiently produces an initial target curve with enough elements to accurately fit the source curve. This is useful later when the curve fitting system performs a global error minimization because it reduces the risk of being stuck in an unsuitable local minimum as well as improves the rate of convergence.

In some embodiments, non-linear optimization is performed using a modified Levenberg-Marquardt algorithm (LMA) with a preconditioned conjugate gradient (PCG) solver. Most software with generic curve-fitting capabilities provide an implementation of LMA. The output of the LMA is a curve fit with minimal error. The LMA is iterative in that to start minimization an initial guess is provided for a parameter vector and the guess is refined over subsequent iterations based on the error in the fit determined by the LMA.

In some embodiments, the curve fitting system uses other methods to fit the target curve to the source curve. A straightforward root-to-tip, per-segment quasi-Newton minimization may be used, but may suffer from stability problems due to accumulated error along the target curve. Exploiting the coupling between a segment and its predecessors, and the curve fitting system can perform a global fit, but this may introduce a vast parameter space with an abundance of local, visually sub-optimal, minima. Working with a coupled Hessian requires the solution of a 3N×3N dense matrix, and each iteration further restricts the resolution of the target curve, as the number of iterations likely will be high. However, these and other methods for fitting curves commonly known to those skilled in the art can be applied to fit the target curve to the source curve.

### Error Analysis

Error analysis determines the difference in the fitted target curve and the source curve. In some embodiments, the curve fitting system determines the error for each segment as each target segment is fitted to each source segment. The curve fitting system may accumulate this segment error to determine an overall error between the source and target curves. The determined error may be used, for example, during segment reduction to determine if removing a particular segment will increase the fitting error to an unacceptable level.

Typically, one end of the curve is fixed, such as hair attached to a human head, while the other end is free to move in space. The location of the fixed end may be provided as input to the simulation, such as through simulation of the position of a simulated head to which the simulated hair is attached. Manipulations of the fixed end of the target curve may introduce more error than manipulations of a free end. For example, with hair, it is usually desirable to distribute the hair uniformly on the head and have the hair stay near to starting position of the source curve. The free end of the target curve, on the other hand, may vary substantially in position from the source curve without producing a visually unsatisfactory result. Thus, error analysis may take into account the position of a segment within the curve when determining the error.

### Segment Reduction

Each segment adds variables that must be calculated during simulation. For example, a Super Helix adds three variables for each curve segment. Thus, it is desirable to adjust the number of segments from the high number that produces the least error to a lower number that still has an acceptably low error and an acceptable computational cost to simulate.

In some embodiments, the curve fitting system reduces the high-resolution fit to a resolution feasible for simulation. For example, the curve fitting system may employ various sampling techniques to determine which segment introduces the least amount of error when removed, distribute that segment's arc length over neighboring segments, remove the determined segment, and perform an adjusting fit to allow the neighboring segments to compensate for the removed segment. The curve fitting system may repeat this procedure until sufficiently many segments have been removed. Due to the high-resolution initial fit and subsequent optimization steps, the curve fitting system can remain sufficiently close to a visually pleasing minimum while still enabling global relaxation iterations using the full coupled system and a PCG solver.

In some embodiments, the system attempts to remove elements, change the length of an element, and/or change the curvature of an element to determine whether the curve fit can be simplified. The system calculates the error in the fit introduced for each variation, and if the error is within an acceptable range, the variation is performed.

### Figures

The following figures illustrate select embodiments and features of the curve fitting system described above.

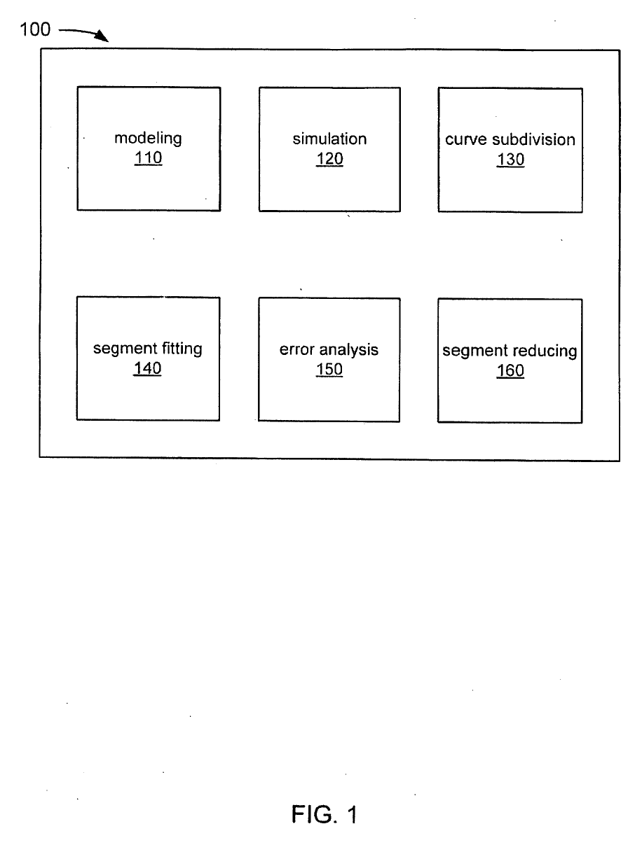

FIG. 1 illustrates the components of the curve fitting system in one embodiment. The curve fitting system 100 contains a modeling component 110, a simulation component 120, a curve subdivision component 130, a segment fitting component 140, an error analysis component 150, and a segment reducing component 160. The modeling component 110 applies a known parametric source curve using common tools to model the behavior of a physical object that can be represented by a curve, such as hair. The curve subdivision component 130 divides the source curve into segments for ease of fitting a target curve to the source curve. The segment fitting component 140 performs a fit of the target curve to each segment of the source curve. The error analysis component 150 determines the error in the fit of each segment and overall for the fit of the target curve to the source curve. The segment reducing component 160 reduces the number of segments in the target curve from the high-resolution initial fit to a lower resolution fit suitable for simulation. The simulation component 120 simulates the behavior of the physical object using the target curve.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

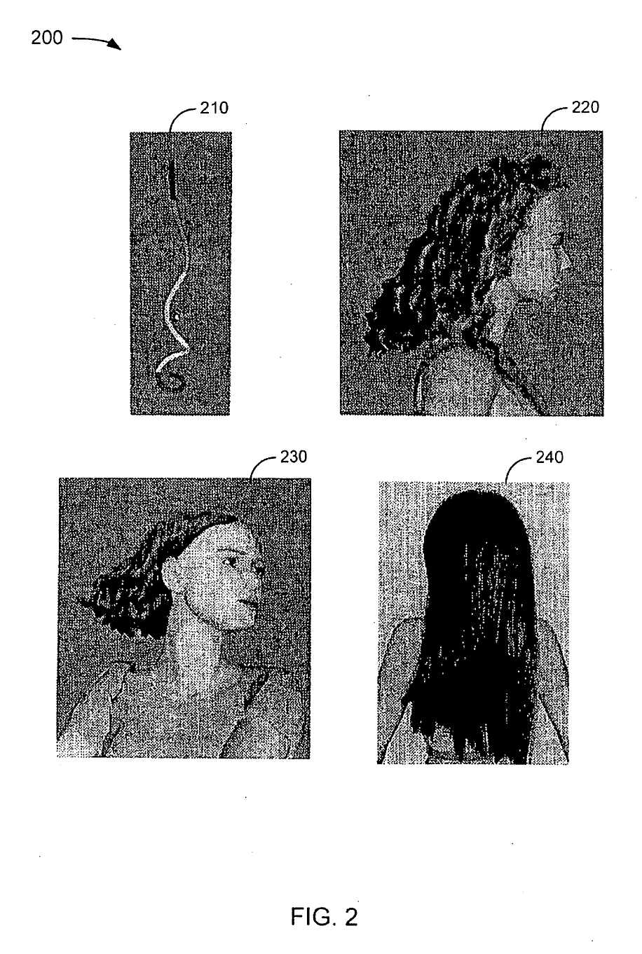

FIG. 2 illustrates the simulation of human hair according to one model. The simulation uses a Super Helix to represent a strand of human hair 210, and multiple strands of human hair 220 acting together. The strand 210 is divided into segments as shown by the differing colors of the strand. Each segment may have different parameters that define the curvedness, direction, and other behavioral characteristics of the segment. As shown in the figure, a simulated human actor having a head of hair performs various movements, and the hair reacts according to the simulation parameters. For example, in block 230, the human actor swings her head to one side, and the hair reacts by swinging around and non deforming elastically. The illustrated model can represent various hair types. For example, block 220 shows curly hair while block 240 shows straight hair.

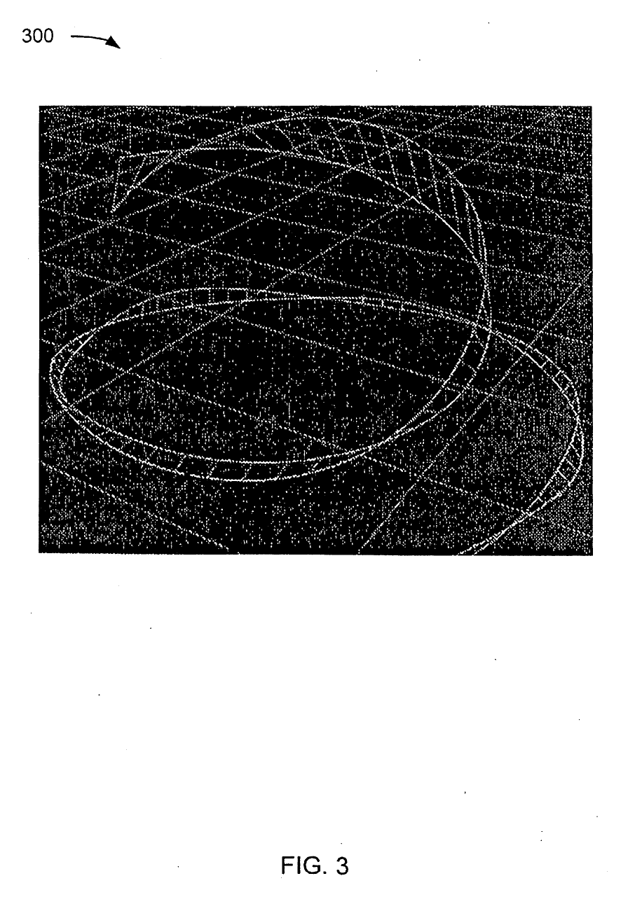

FIG. 3 illustrates the fitting of a Super-Helix curve to an arbitrary NURBS curve. As shown in the figure the two curves follow close to the same path. However, the dashed lines in the figure illustrate the distance between the NURBS curve at various points from the Super-Helix curve. This distance represents the error in the fit of the curves. The error is minimized by the methods described herein, and the overall fit is visually very similar.

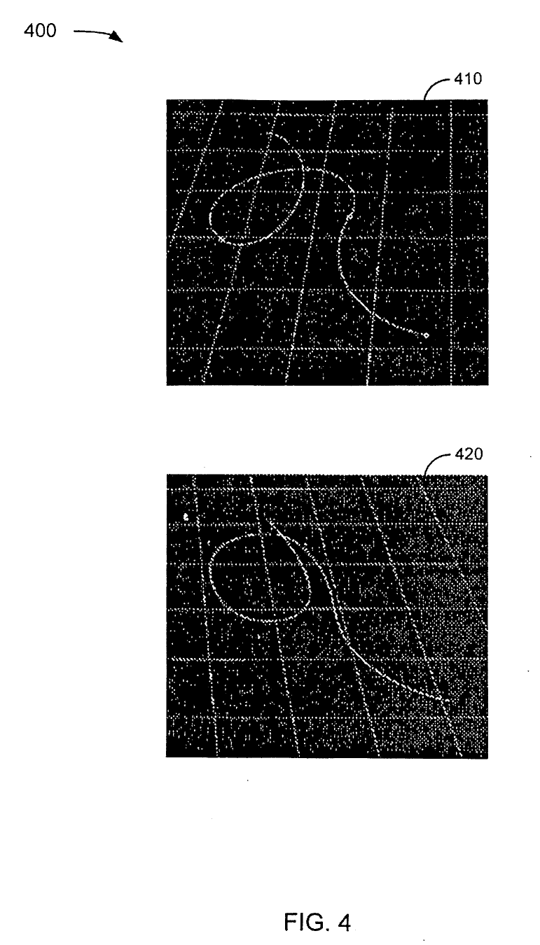

FIG. 4 illustrates a fitted Super-Helix curve and the source NURBS curve. As shown in the figure a Super-Helix curve 410 is above and a source NURBS curve 420 is below. The two curves follow close to the same path. Also shown in the figure, the NURBS curve 420 and Super Helix curve 410 start at a roughly similar fixed point at the bottom of the figure, while the free ends vary more substantially at the top of the figure. This is because, as described herein, error at the fixed end of a curve is more noticeable than error at the free end of the curve. Thus, the curve fitting error in the figure has been minimized in such a way that the fixed end has relatively little error, while the free end is allowed to have greater error.

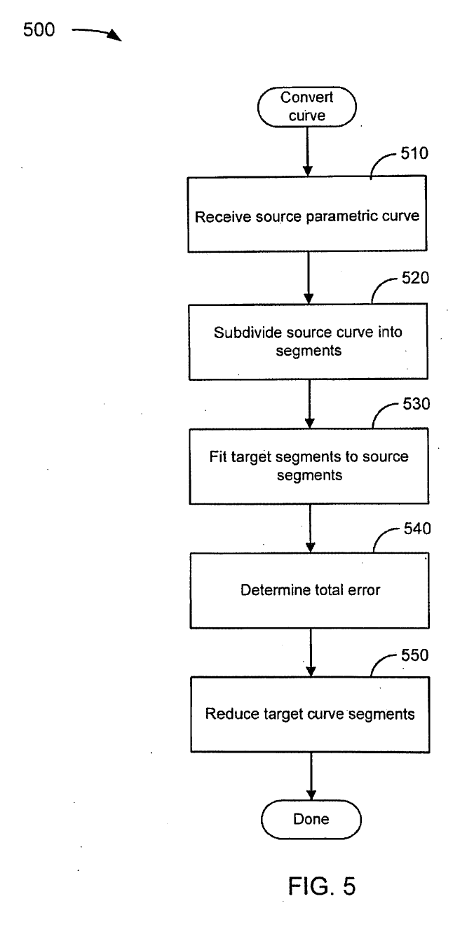

FIG. 5 is a flow diagram that illustrates the steps performed by the curve fitting system in one embodiment. In block 510, the system receives a source parametric or other curve. In block 520, the system subdivides the source curve into segments. For example, the source curve may be divided into segments based on a desired segment length or based on the variance in curvature throughout the source curve. In block 530, the system fits segments of the target curve to segments of the source curve. In block 540, the system determines the error in the fit of the target curve to the source curve. In block 550, the system reduces the number of segments in the target curve to produce a curve fit that is suitable for simulation while still providing a visually acceptable fit to the source curve. After block 550, these steps conclude.

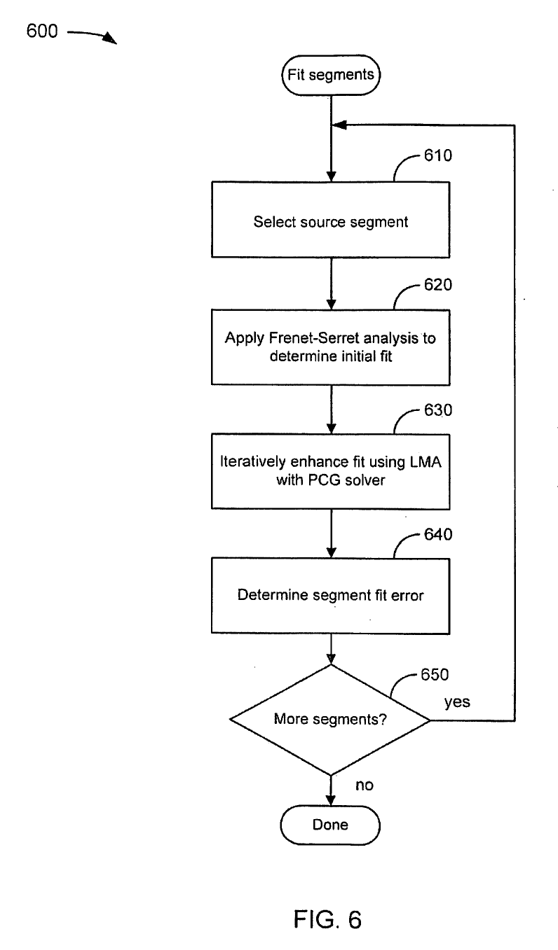

FIG. 6 is a flow diagram that illustrates the steps performed by the segment fitting component in one embodiment. The component is invoked to fit segments of a target curve to segments of a source curve. In block 610, the component selects a source segment to fit. The source segment may be selected in various ways. For example, the component may perform a root-to-tip selection of the segments, or the segments may be chosen by more complex methods described herein. In block 620, the component applies Frenet-Serret or other analysis to produce an initial target segment to fit to the source segment. In block 630, the component iteratively refines the fit using the LMA with a PCG solver, or another suitable algorithm for iteratively improving the fit of the target segment to the source segment. In block 640, the component determines the error in the fit of the target segment to the source segment. Based on the determined error, the component may perform additional steps to produce a better fit, or may simply record the error for use later. In decision block 650, if there are more source segments to fit, then the component loops to block 610 to select the next source segment, else the component completes.

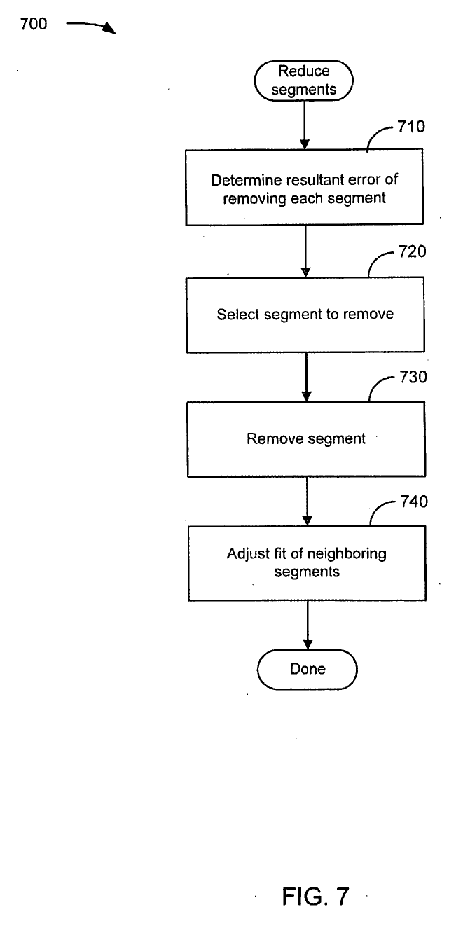

FIG. 7 is a flow diagram that illustrates the steps performed by the segment reducing component in one embodiment. The component is invoked to reduce the number of segments in the target curve to a number suitable for simulation of the target curve. Segment reduction reduces the computation cost which is helpful particular when thousands of curves are simulated simultaneously (such as a head of hair or blades of grass). In block 710, the component determines the resultant error of removing each segment. For example, removing the root segment may introduce a high amount of error, while reducing an interior segment at a part of the curve with little curvature may introduce very little error. In block 720, the component selects a segment to remove based on the determined resultant error. For example, the component may remove the segment that introduces the least amount of error upon removal. In block 730, the component removes the selected segment. In block 740, the component adjusts the fit of segments neighboring the removed segment to compensate for the removed segment. After block 740, these steps conclude.

From the foregoing, it will be appreciated that specific embodiments of the curve fitting system have been described herein for purposes of illustration, but that various modifications may be made without deviating from the spirit and scope of the invention. Although hair has been used as an example of the type of soft body that can be used with the system, the described methods apply to many other types of soft bodies as well. For example, blades of grass, cloth fibers, and other materials that can be represented using curve segments can be used. In addition, these methods are applicable to many fields, such as movies, video games, medicine (e.g., angioplasty simulation), the cosmetic industry, and so forth. Accordingly, the invention is not limited except as by the appended claims.

I/We claim:

1. A method in a computer system for modeling substantially inextensible physical objects, the method comprising:
receiving an arbitrary curve that describes a substantially inextensible physical object;
modeling one or more properties of the physical object based on the received arbitrary curve;
converting the arbitrary curve into a super helix by subdividing the arbitrary curve into segments and fitting a segment of the super helix curve to each segment of the arbitrary curve; and
simulating a behavior of the physical object based on the super helix curve.

2. The method of claim 1 wherein the physical object is a strand of hair.

3. The method of claim 1 wherein the physical object is a blade of grass.

4. The method of claim 1 wherein the subdividing is performed based on the variance of the curvature of the arbitrary curve.

5. The method of claim 1 wherein fitting a segment comprises determining a fit that minimizes a segment error determined between the segment of the arbitrary curve and the segment of the super helix curve.

6. The method of claim 1 wherein fitting a segment comprises determining an end condition of a previous segment.

7. The method of claim 1 wherein converting further comprises reducing the number of segments in the super helix curve.

8. The method of claim 1 wherein the inextensible physical object is constrained at one end.

9. A computer system for converting a NURBS curve into a super helix curve, the system comprising:
a curve subdividing component configured to subdivide the NURBS curve into segments, wherein the NURBS curve represents a substantially inelastic physical object fixed to a second object at one end;
a segment fitting component configured to fit a segment of the super helix curve to a segment of the NURBS curve for each segment of the NURBS curve;
an error analysis component configured to determine an error of the fit of the super helix curve to the NURBS curve; and
a segment reducing component configured to remove one or more segments from the super helix curve to reduce the computational cost of simulating the super helix curve.

10. The system of claim 9 wherein the physical object is human hair.

11. The system of claim 9 wherein the physical object is a fiber of cloth.

12. The system of claim 9 wherein the error analysis component determines the error of the fit by determining an error of the fit of each segment.

13. The system of claim 9 wherein the curve subdividing component subdivides the NURBS curve based on an adaptive subdivision scheme.

14. The system of claim 9 wherein the segment reducing component removes the segment that introduces a smallest resultant error.

15. A method in a computer system for converting a first curve described by a first model into a second curve described by a second model, the method comprising:
subdividing the first curve into segments;
for each segment of the first curve, fitting a segment of the second curve to the first curve; and
determining a total error of the fit of the second curve to the first curve.

16. The method of claim 15 wherein the subdividing is performed based on the variance of the curvature.

17. The method of claim 15 wherein the subdividing is performed based on iterating from the root-to-tip of the first curve.

18. The method of claim 15 wherein fitting a segment comprises determining a fit that minimizes a segment error determined between the segment of the first curve and the segment of the second curve.

19. The method of claim 18 wherein the segment error is determined based on the difference in the first curve segment and the second curve segment.

20. The method of claim 15 wherein fitting a segment comprises determining an end condition of a previous segment.

21. The method of claim 15 wherein determining the total error comprises accumulating an error determined for each segment.

22. The method of claim 15 including reducing the number of segments in the second curve.

23. The method of claim 22 wherein reducing the number of segments comprises selecting a segment for removal based on determining an additional error introduced by removing each segment.

24. The method of claim 23 including selecting the segment determined to introduce the least additional error.

25. The method of claim 22 wherein reducing the number of segments comprises selecting a segment for removal based on the position of the segment in the second curve.

26. The method of claim 25 wherein the position is selected based on whether the segment is near a root segment of the second curve.

27. A computer system for converting a first curve described by a first model into a second curve described by a second model, the system comprising:
a curve subdividing component configured to subdivide the first curve into segments;
a segment fitting component configured to fit a segment of the second curve to a segment of the first curve for each segment of the first curve;
an error analysis component configured to determine an error of the fit of the second curve to the first curve; and
a segment reducing component configured to remove one or more segments from the second curve to reduce the computational cost of simulating the second curve.

28. The system of claim 27 wherein the error analysis component determines the error of the fit by determining an error of the fit of each segment.

29. The system of claim 27 wherein the curve subdividing component subdivides the first curve based on an adaptive subdivision scheme.

30. The system of claim 27 wherein the segment reducing component removes the segment that introduces a smallest resultant error.

31. A computer-readable storage medium encoded with instructions for controlling a computer system to model and simulate the behavior of a physical object, by a method comprising:
receiving a first curve described by a first method;
modeling one or more properties of the physical object based on the received first curve;
converting the first curve into a second curve described by a second method; and
simulating a behavior of the physical object based on the second curve.

32. The computer-readable medium of claim 31 including rendering the simulated physical object to film.

33. The computer-readable medium of claim 31 including rendering the simulated physical object to a nonvolatile storage device.

34. The computer-readable medium of claim 31 wherein the first method is a method that describes a parametric NURBS curve and the second method is a method that describes a Super Helix curve.
